(19) United States
(12) Patent Application Publication
(10) Pub. No.: US 2026/0184281 A1
(43) Pub. Date: Jul. 2, 2026

(54) AN AIRBAG

(71) Applicant: AUTOLIV DEVELOPMENT AB, Vargarda (SE)

(72) Inventors: Venkata KRISHNA, Karnataka (IN); Dobrila LUCIC, Göteborg (SE); Gary WOOTTON, Stoke-on-Trent Staffordshire (GB); Henrik BALAGUE, Falköping (SE); Shashank GOWDA, 577448 (IN)

(21) Appl. No.: 19/127,337

(22) PCT Filed: Nov. 28, 2023
(86) PCT No.: PCT/EP2023/083354

§ 371 Date: May 5, 2025

(30) Foreign Application Priority Data
Dec. 20, 2022 (DE) 10 2022 134 130.5

(51) Int. Cl. B60R 21/235; A41D 13/05; B60R 21/2338; D03D 1/02; D03D 11/02

(52) U.S. Cl. CPC B60R 21/235; A41D 13/0506; B60R 21/2338; D03D 1/02; D03D 11/02; B60R 2021/23509; B60R 2021/23542; B60R 2021/23571; D10B 2403/0333

(57) ABSTRACT

An airbag is formed from first and second layers of fabric arranged in superimposition to define an inflatable chamber between the layers for the receipt of inflating gas. Each layer of fabric has a structure comprising at least one yarn, and the two layers are interconnected by a plurality of substantially parallel tether yarns extending in a length-direction across at least a region of the airbag and passing between the layers within the inflatable chamber. The first layer comprises a plurality of spaced-apart first connection regions within which tether yarns selected from said plurality of tether yarns are implicated in the structure of said first layer. The second layer comprises a grid-like arrangement of second connection regions within which tether yarns-selected from said plurality of tether yarns are implicated in the structure of said second layer.

### FIELD OF THE INVENTION

The present invention relates to an airbag configured to be inflated by a source of inflating gas, and more particularly relates to an inflatable airbag having an integral tether arrangement to induce curvature to the airbag upon inflation.

### BACKGROUND

It is well known and now very common practice to provide an airbag in a motor vehicle such that in the event of an accident involving the motor vehicle, the airbag is inflated to adopt an inflated position between the head or body of a vehicle occupant and the structure of the motor vehicle in order to provide protection to the occupant by reducing the likelihood of injurious impact between the occupant's head or body and the structure of the vehicle. It is also now becoming common to provide airbags on the exterior of motor vehicles, in order that the airbags may inflate in the event of a detected or predicted collision with a pedestrian or other vulnerable road user (“VRU”) such as a cyclist, thereby offering similar protection to the vulnerable road user by cushioning their impact with the motor vehicle during an accident.

Furthermore, there have also been several proposals to provide airbags as part of personal protection arrangements configured to be worn by people undertaking high risk tasks. For example, personal fall protection systems may include one or more airbags configured to inflate upon detection of the wearer being likely to fall, and to thereby adopt an inflated position against part of the wearer's body, such as the hip area, in order to provide protection against injury arising from the fall.

To ensure the provision of effective protection, it is often desirable to provide an airbag that is configured to adopt a somewhat curved or bent shape upon inflation. An example here is a side impact airbag provided within the cabin of a motor vehicle and configured to adopt an inflated position between an occupant of the vehicle and the side structure of the vehicle to provide protection to the occupant in the event of a side impact. In the case of such side impact airbags, it may be advantageous for the airbag to adopt an inflated shape which is somewhat concave towards the occupant, in order to ‘catch’ the occupant's head and/or torso, thereby reducing the likelihood of the occupant's head or torso sliding forwardly or rearwardly across the airbag under the force of inertia, and out of protective contact with the airbag. So-called knee airbags are another example of airbags where a curved inflated shape can be advantageous. Knee airbags are typically installed at a low position in the footwell of a motor vehicle (for example on the underside of a vehicle's dashboard), and may be configured to curve upwards in their inflated configuration to extend from their installation position and around the dashboard in order to provide sufficient protection to an occupant's knees.

So-called inflatable curtain (IC) airbags may also be advantageously configured to adopt a somewhat curved shape upon inflation in order to improve their protective performance. An inflatable curtain airbag is provided within a motor vehicle in a position such that in the event of an accident involving a side impact or a roll-over incident, the airbag is inflated so as to become disposed between the side of the vehicle and the head of a vehicle occupant in order to protect against the occupant's head coming into contact with or passing through a window in the side of the vehicle. Typically, inflatable curtain airbags are configured to extend across the entire side window region of a motor vehicle, and it has been found that a degree of curvature induced into the inflated shape of such an airbag can be effective in increasing the airbag's area of coverage, for example in the A-pillar region of the motor vehicle where the side window meets the rearwardly sloping frame of the front windscreen. Personal fall protection arrangements represent another example of airbags whose protective performance can be improved by having a somewhat curved inflated shape. For example, a hip-protector airbag should be configured to wrap itself around the user as it deploys, rather than deploy in a direction away from the user, in order to offer optimal protection. Furthermore, hip-protector airbags represent an example of airbag whose performance can be further optimised by having a configuration which induces double curvature to the airbag in its inflated configuration, thereby achieving two types of curvature namely a first curvature around the user's vertical axis (so that the airbag extends around the sides of the wearer's hips upon deployment), and a second curvature around the user's sagittal axis (so that the airbag extends underneath the user's hips and buttocks, particularly when in a seated position).

As the skilled person will readily understand, there are many other examples of airbags for which double curvature are desirable upon deployment-for example personal fall protection garments in the form of vests, trousers, helmets, shorts, trousers of the like.

It is also envisaged that a convenient way to achieve a curved shape upon inflation of an airbag could facilitate the provision of airbags for all manner of different uses.

The present invention has been devised in light of the above considerations.

### SUMMARY OF THE INVENTION

According to a first aspect of the present invention, there is provided an airbag configured to be inflated by a source of gas, the airbag being formed from first and second layers of fabric arranged in superimposition to define an inflatable chamber between the layers for the receipt of inflating gas. Each layer of fabric has a structure comprising at least one yarn and the two layers are interconnected by a plurality of substantially parallel tether yarns extending in a length-direction across at least a region of the airbag and passing between the layers within the inflatable chamber. The first layer of fabric comprises a plurality of spaced-apart first connection regions within which tether yarns selected from said plurality of tether yarns are implicated in the structure of said first layer. The second layer of fabric comprises a grid-like arrangement of second connection regions within which tether yarns selected from said plurality of tether yarns are implicated in the structure of said second layer. The grid-like arrangement of second connection regions divides at least a region of the second layer into an array of sectors. The first connection regions are offset relative to the second connection regions such that each first connection region of the first layer is located opposite a respective sector of the second layer and does not oppose any said second connection region across the inflatable chamber. The first connection regions are each wider than said second connection regions in the length-direction of said tether yarn. The tether yarns serve to induce double curvature to the airbag when the inflatable chamber is inflated.

The fabric layers may be woven, in which case the structure of each fabric layer will be a weave comprising a plurality of parallel warp yarns, and a plurality of parallel weft yarns. For example, the fabric layers may have a plain weave, but could alternatively have other weave configurations.

Alternatively, it is envisaged that the fabric layers could be knitted, in which case the structure of the fabric layer will be a knit comprising at least one yarn forming interlocking loops. For example, the knit of fabric layers may be a so-called weft knit comprising a single yarn. Alternatively, the knit of the fabric layers may be a so-called warp knit comprising loops formed from separate yarns.

The airbag may comprise a peripheral seam interconnecting the first and second layers to define the inflatable chamber.

Preferably, at least one said first connection region comprises a central sub-region within which no tether yarns are implicated in the structure of said first layer, said central sub-region being bordered by a border sub-region throughout which tether yarns are implicated in the structure of said first layer. In such arrangements of first connection region(s), at least some tether yarns thus pass across said central sub-region between parts of the border sub-region without being implicated in the structure of either the first layer or the second layer.

Alternatively, or additionally, at least one said first connection region may comprise a central sub-region within which no tether yarns are implicated in the structure of said first layer, said central sub-region being: (i) partially bordered by said peripheral seam so as to extend inwardly from said peripheral seam across said first layer; and (ii) partially bordered by a border sub-region throughout which tether yarns are implicated in the structure of said first layer. In such arrangements of first connection region(s), at least some tether yarns pass across said central sub-region between parts of the border sub-region without being implicated in the structure of either the first layer or the second layer.

Alternatively, or additionally, at least one said first connection region may be configured such that tether yarns are implicated in the structure of said first layer throughout the width of the first connection region in the length-direction of said tether yarns.

Preferably, tether yarns are implicated in the structure of the second layer substantially throughout said second connection zones.

Optionally, the airbag may be configured such that at least some of said tether yarns pass, in a length-direction of said tether yarns: from a said second connection region, through a said first connection region, and then into another said second connection region.

In some embodiments, at least some of said yarns may pass, in a length-direction of said tether yarns, from either a said first connection region or a said second connection region into said peripheral seam.

Optionally, the airbag may be configured such that at least some said tether yarns pass, in a length-direction of said tether yarns, through a plurality of said first connection regions and a plurality of said second connection regions.

In some embodiments it is proposed that said second connection regions intersect at nodes at which said first and second layers are directly interconnected.

Conveniently, each said layer of fabric is woven and has a weave comprising a plurality of generally parallel woven yarns, said tether yarns being interwoven with said yarns of the first layer within each said first connection region, and being interwoven with said yarns of the second layer within each said second connection region.

Advantageously, said tether yarns are interwoven with yarns of said layers only within said connection regions. In some such embodiments having a first connection region comprising a central sub-region bordered by a border sub-region, each such first connection region may be configured such that said tether yarns are interwoven with yarns of the first layer only within the or each said border sub-region, and are interwoven with yarns of the second layer only within said second connection regions. In embodiments having a first connection region comprising a central sub-region partially bordered by said peripheral seam, each such first connection region may be configured such that said tether yarns are interwoven with yarns of the first layer only within said peripheral seam or the or each said border sub-region, and are interwoven with yarns of the second layer only within said second connection regions or said peripheral seam.

It is envisaged that said generally parallel woven yarns of each layer of fabric may be warp yarns, with each layer of fabric further comprising a plurality of generally parallel weft yarns. In such arrangements, it is envisaged that the tether yarns may extend generally parallel to the weft yarns of the fabric layers—i.e. the length-direction of the tether yarns will be aligned with the length-direction of the weft yarns, and thus may be orthogonal to the length-direction of the warp yarns. Alternatively, it is envisaged that each tether yarn may extend generally parallel to said warp yarns.

In order to provide good bending characteristics in some embodiments, it is envisaged that said first and second connection regions may each traverse said weft yarns at an oblique angle to said weft yarns and may each also traverse said warp yarns at an oblique angle to said warp yarns.

Conveniently, it is envisaged that the airbag may be a one-piece woven airbag comprising at least one integrally woven seam defined by a region in which yarns of the weave of one said layer are interwoven with yarns of the weave of the other said layer. In such arrangements, the integrally woven seam may be the aforementioned peripheral seam interconnecting said first and second layers to define said inflatable chamber, and each said tether seam may be integrally woven into the weave of said layers within said peripheral seam.

Optionally, said nodes at which the second connection regions intersect may be defined by regions in which yarns of the weave of one said layer are interwoven with yarns of the weave of the other said layer. In such arrangements, at least some of said tether yarns may be integrally woven into the weave of said layers within said nodes.

Conveniently, said first connection regions may be spaced apart from one another across at least a portion of said first layer (e.g. in the length-direction of the tether yarns), and said second connection regions may be spaced apart from one another across at least an opposing portion of said second layer.

The position on said second fabric layer of at least one said second connection region may be interposed between the positions on said first fabric layer of two adjacent first connection regions.

At least some said tether yarns may be arranged so as not to extend between any of said second connection regions without being implicated in the structure of the first layer between said second connection regions.

The tether yarns may extend generally orthogonal to said generally parallel woven yarns of the weave of the first and second layers.

There may be provided a significant number of tether yarns arranged in a side-by-side relationship to one another, for example with the tether yarns being distributed amongst the weft yarns of the two fabric layers so as to extend generally parallel to the weft yarns and perpendicular to the warp yarns, or vice-versa, and thereby collectively defining a tether having a width which extends some distance along the warp-direction (or the weft direction) of the fabric. In some embodiments, it is proposed that the tether yarns may collectively define a tether having a width extending substantially entirely across the airbag, such that tether yarns are provided throughout the airbag. In some embodiments it is envisaged that the tether yarns may be provided within a third layer of fabric woven from a third set of warp yarns and the tether yarns, wherein the tether yarns define weft yarns of the third layer of fabric. Alternatively, the tether yarns may be provided within a third layer of fabric woven in a manner such that the tether yarns define warp yarns of the third layer.

Whilst embodiments are described herein and illustrated in the accompanying drawings in which tether yarns are implicated in the weave of the constituent fabric layers by passing between or partly around (e.g. by being interwoven with) warp yarns of a woven airbag, it is proposed that in other embodiments the tether yarns may instead be arranged to pass between or at least partly around (e.g. by being interwoven with) weft yarns of the airbag. In such embodiments it will therefore be appreciated that the tether yarns are distributed amongst the warp yarns of the constituent layers of fabric rather than amongst the weft yarns as described with reference to specific embodiments disclosed herein.

The fabric layers of the airbag, and optionally also an internal tether defined by the tether yarns, may be provided with a surface coating or film. In the case of the airbag's main constituent layers of fabric, the coating or film may be applied either on their inside surface, their outside surface, or both. For example, it is proposed that a heat resistant coating or film may be applied to the fabric layers and/or the tether, in order to protect the fabric and yarns from high temperatures which may arise during inflation due to the high temperature of the inflating gas produced by an inflator. Alternatively, or additionally, the coating or film may provide a sealing function, effective to prevent or reduce the leakage of inflating gas between the yarns of the airbag during inflation. This may be particularly advantageous around the connection regions of the two fabric layers, where the tether yarns are implicated in the structure (e.g. the weave) of the fabric layers, because there may be a tendency for the tether yarns to pull warp or weft yarns of the fabric layers apart from one another as the tether yarns are subjected to tension during inflation of the airbag, thereby opening up small gaps through which inflation gas may otherwise leak.

The invention includes the combination of the aspects and preferred features described except where such a combination is clearly impermissible or expressly avoided.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### SUMMARY OF THE FIGURES

So that the invention may be more readily understood, and so that further features thereof may be appreciated, embodiments of the invention will now be described by way of example with reference to the accompanying drawings in which:

FIG. 1 is a perspective view of a section through part of a prior art airbag, showing a known internal tether arrangement;

FIG. 2 is diagrammatic sectional view of a conventional internal tether arrangement provided within an airbag;

FIG. 3 is a diagrammatic sectional view of another conventional internal tether arrangement within an airbag;

FIG. 4 is a diagrammatic section view of an internal tether arrangement provided within an airbag in accordance with an aspect of the present invention;

FIG. 5 is a diagrammatic sectional view showing one way in which a tether yarn may be implicated in the weave of a layer of the airbag;

FIG. 6 is a diagrammatic sectional view showing another way in which a tether yarn may be implicated in the weave of a layer of the airbag;

FIG. 7 is a diagrammatic view of an airbag showing a plurality of connection regions where tether yarns are implicated in the weave of a layer of the airbag;

FIG. 8 is a diagrammatic sectional view similar to that of FIG. 4, but which shows the tether arrangement inducing curvature to the airbag upon inflation;

FIG. 9 is a cross-sectional view through an inflated airbag, illustrating curvature induced to the airbag upon inflation;

FIG. 10 is a perspective view of an uninflated airbag in accordance with an aspect of the invention;

FIG. 11 is another perspective view of the airbag illustrated in FIG. 10, but which shows the airbag in an inflated, and curved, configuration;

FIG. 12 is a schematic illustration, from the front, of a pair of specific airbags inflated around the hip region of a person to provide protection to the hip region of the person;

FIG. 13 is a schematic illustration, from below, of the pair of airbags of FIG. 12 inflated around the person's hip region;

FIG. 14 is a schematic illustration similar to that of FIG. 12, but which shows a pair of specific airbags of alternative configuration to those of FIGS. 12 & 13;

FIG. 15 is a schematic illustration, from below, of the pair of airbags of FIG. 14 inflated around the person's hip region;

FIG. 16 is a schematic plan view of an airbag in accordance with an embodiment of the present invention, in an uninflated configuration;

FIG. 17 is a schematic plan view of the airbag illustrated in FIG. 16, but which shows the airbag in an inflated configuration;

FIG. 18 is a perspective view showing the inflated configuration of the airbag illustrated in FIG. 17 from one side of the airbag;

FIG. 19 is a perspective view showing the inflated configuration of the airbag illustrated in FIGS. 17 and 18 from an opposite side of the airbag;

FIG. 20 is a schematic plan view of an airbag in accordance with another embodiment of the present invention in an uninflated configuration;

FIG. 21 is a perspective view showing the airbag of FIG. 20 from one side and in an inflated configuration; and FIG. 22 is a perspective view showing the airbag of FIGS. 20 and 21 from an opposite side of the airbag in the inflated configuration.

### DETAILED DESCRIPTION OF THE INVENTION

Aspects and embodiments of the present invention will now be discussed with reference to the accompanying figures. Further aspects and embodiments will be apparent to those skilled in the art.

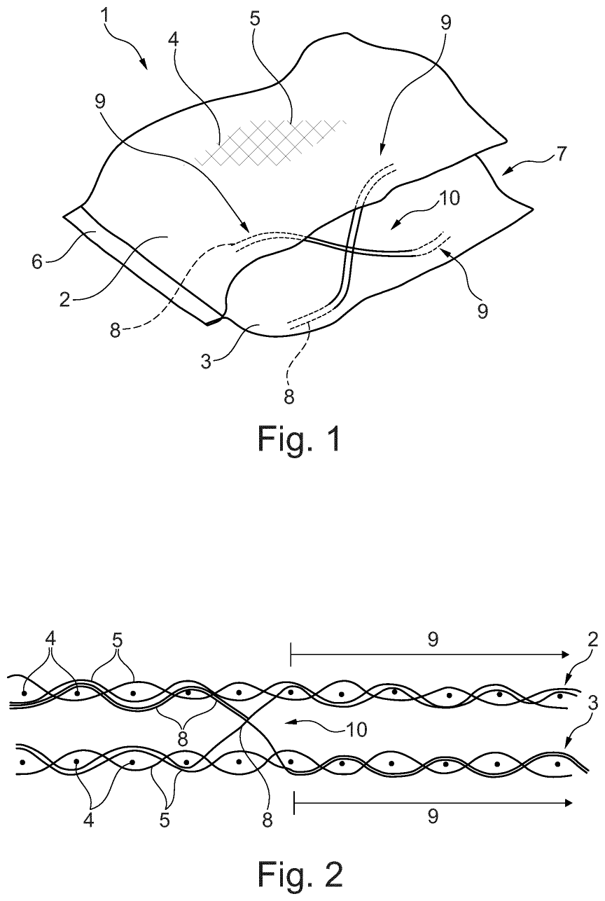

Turning initially to consider FIG. 1, there is illustrated a region of an airbag 1 which is configured to be inflated by a source of gas. As will be appreciated, and as is conventional, the airbag 1 is formed from first (upper) and second (lower) layers of fabric 2, 3, each of which is woven from warp yarns 4 and weft yarns 5 and thus has a structure in the form of a weave. It is to be appreciated, however, that the invention may alternatively be applied to an airbag in which the layers of fabric are knitted layers, in which case the layers will have a structure in the form of a knit comprising at least one yarn.

The two layers of fabric 2, 3 are arranged in superimposition, and are interconnected around their peripheral edges by a peripheral seam 6 (only part of which is shown in FIG. 1), thereby defining an inflatable chamber 7 between the layers 2, 3 for the receipt of inflating gas from an inflator (not shown) such as a gas generator, in a known manner. The airbag 1 may be woven via a so-called one-piece weaving technique, in which the two layers 2, 3 are woven simultaneously, with the yarns 4, 5 of the two layers 2, 3 being interwoven at predetermined regions to form the peripheral seam 6 (and optionally other seams and/or other interconnections not shown in FIG. 1) as an integral structural feature of the airbag 1. An exemplary one-piece weaving technique for making an airbag is described in more detail in International Patent Publication WO199009295A.

The airbag 1 illustrated in FIG. 1 has a known configuration of integrally woven internal tether arrangement. At selected positions throughout the layers 2, 3, additional tether yarns 8 are also woven into the weave of the fabric, as illustrated schematically in FIG. 1 and in more detail in FIG. 2. The tether yarns 8 are woven so as to extend substantially parallel with the weft yarns 5 of the fabric (and thus substantially perpendicular to the warp yarns 4), and pass over and under successive warp yarns 4 within predetermined connection regions 9 so as to be implicated in the weave of the layers 2, 3 at the connection regions 9. The tether yarns 8 may have a different construction to the warp and weft yarns 4, 5 of the fabric layers 2, 3, such as described in European patent publication EP2407353A.

At the edges of each connection region 9, the tether yarns 8 pass out of the respective fabric layer 2, 3 in which they are woven and extend towards the opposing layer 3, 2. In the particular arrangement illustrated in FIGS. 1 and 2, the tether yarns 8 each extend into the opposing fabric layer 3, 2 and are woven integrally with it at another connection region 9. As will thus be noted from FIG. 2, the tether yarns 8 are arranged to cross one another, passing out of one fabric layer 2, 3 and extending into the other fabric layer 3, 2. The tether yarns 9 thus cooperate to define a tether 10 which serves to interconnect the two fabric layers 2, 3 within and across the inflatable chamber 7 of the airbag 1. As illustrated in FIG. 2, each tether 10 may be defined by a plurality of tether yarns 8; in this case two pairs of crossing tether yarns 8.

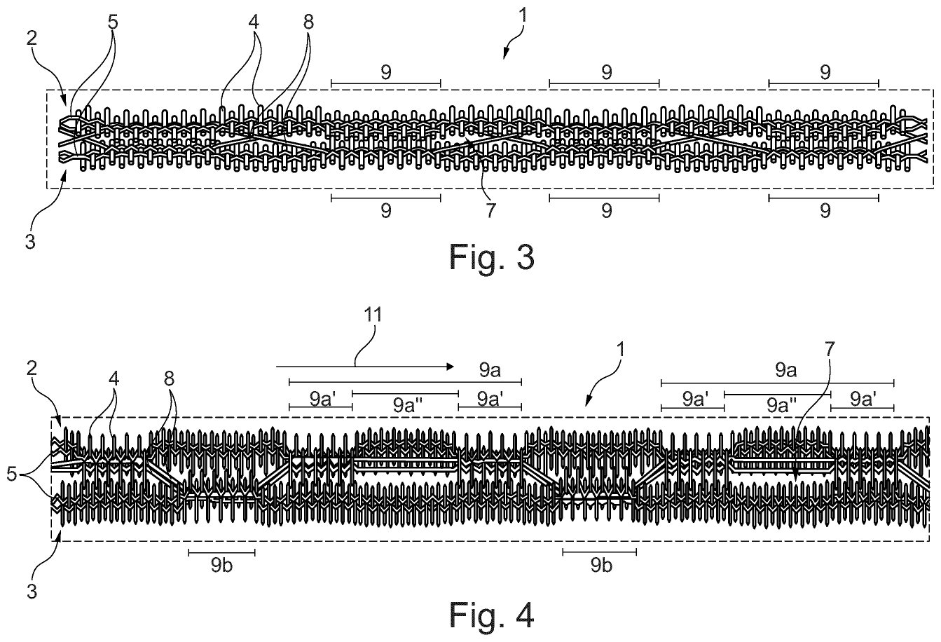

FIG. 3 illustrates a larger expanse of the two fabric layers 2, 3, from which it will be seen that the tether yarns 8 are each implicated in the structure (i.e. in the weave) of the two layers 2, 3 at a plurality of connection regions 9. In the prior art arrangement shown in FIG. 3, each layer 2, 3 has a plurality of spaced-apart connection regions 9 within which the tether yarns are interwoven with the fabric of the respective layer 2, 3. Furthermore, it will be noted that each connection region 9 of the first layer 2 is located opposite a respective connection region 9 of the second layer 3, across the inflatable chamber 7 defined between the two layers 2, 3.

FIG. 3 illustrates the two fabric layers 2, 3 located generally adjacent one another, as would be the situation in the uninflated condition of the airbag 1. As will be appreciated by those of skill in the art, as the airbag 1 is inflated by the injection of inflating gas into the inflatable chamber 7, the first and second layers 2, 3 of the airbag 1 will begin to move apart such that the airbag will begin to achieve an inflatable configuration. During inflation, the tether yarns 8 will become tensioned, thereby cooperating to resist further movement of the two layers 2, 3 apart from one another as the airbag 1 is inflated, which can serve an important function in controlling the inflated depth or thickness of the airbag 1 in certain airbag installations, such as those involving the use of the airbag 1 in a safety arrangement within a motor vehicle.

Turning now to consider FIG. 4, there is illustrated a tether arrangement for an airbag 1 in accordance with an aspect of the present invention, which offers a significant advantage over the conventional arrangement described above and illustrated in particular in FIGS. 2 and 3. As will be apparent to those of skill in the art, the tether arrangement illustrated in FIG. 4 shares several features and similarities with the conventional arrangement shown in FIGS. 2 and 3, which will therefore not be described in detail again. Nevertheless, it is to be noted that the airbag 1 in accordance with the invention may also be formed by a one-piece weaving technique such as that disclosed in International Patent Publication WO199009295A, and may incorporate tether yarns 8 having a different construction to the warp and weft yarns 4, 5 of the airbag's fabric layers 2, 3, such as described in European patent publication EP2407353A.

As will be observed, in the arrangement illustrated in FIG. 4 the tether yarns 8 do not cross one another as they pass out of the weave of one fabric layer and into the weave of the other fabric layer. In contrast to the conventional arrangement illustrated in FIGS. 2 and 3, the tether yarns 8 instead each follow a substantially similar path through the weave of the two layers 2, 3. In particular, it will be observed that the tether yarns 8 follow a path in which they are each implicated in the weave of the first layer 2 (for example by being interwoven with warps yarns 4 of the first layer 2) within a plurality of first connection regions 9a, and in which they are each implicated in the weave of the second layer 3 (for example by being interwoven with warps yarns 4 of the first layer 2) within a plurality of second connection regions 9b. The tether yarns 8 are interwoven with the yarns of the fabric layers 2, 3 only within the connection regions 9a, 9b. It is envisaged that the warp yarns 8 will be integrally woven into the weave of the two layers of fabric 2, 3, within the connection regions 9a, 9b during the one-piece weaving process by which the fabric layers 2, 3 themselves are simultaneously woven.

As illustrated in FIG. 4, in the particular arrangement illustrated, each first connection region 9a actually comprises a pair of connection sub-regions 9a′ which are spaced apart from one another in the weft direction 11 of the first layer of fabric 2 so as to define a central sub-region 9a″ therebetween. Within each first connection region 9a, it will be observed that the tether yarns 8 are interwoven with the yarns of the first layer of fabric 2 only within the connection sub-regions 9a′. The tether yarns 8 thus pass between the connection sub-regions 9a′ within each first connection region 9a without being implicated in the weave structure of the first layer 2 (or indeed the second layer 3). Between the connection sub-regions 9a′, the tether yarns 8 simply pass across the central sub-region 9a″ adjacent the first fabric layer 2, within the inflatable chamber 7 of the airbag. It is to be appreciated, however, that in other embodiments, the tether yarns 8 may be interwoven with the yarns of the first layer of fabric 2 throughout the width (in the weft direction 11) of each first connection region 9a, in which case there will be no discrete sub-regions 9a′ as described above.

The first connection regions 9a themselves are also spaced apart from one another in the weft direction 11 of the first layer of fabric 2, and indeed the second connection regions 9b are also spaced apart from one another in the weft direction 11 of the second layer of fabric 3. Significantly, it will be observed that the tether yarns 8 are implicated in the weave of the layers of fabric 2, 3 in an arrangement in which each first connection region 9a is wider in a length-direction of the tether yarns 8 (i.e. corresponding to the weft direction 11 in this embodiment) than each of the second connection regions 9b. It will also be observed that there is a greater number of connection sub-regions 9a′ (i.e. where the tether yarns 8 are actually implicated in the weave of the first layer 2) than second connection regions 9b (i.e. where the tether yarns 8 are implicated in the weave of the second layer 3). Furthermore, it will be observed that the first connection regions 9a and the second connection regions 9b are offset relative to one another in the weft direction 11 of the fabric layers 2, 3, such that the first connection regions 9a of the first layer of fabric 2 do not oppose any of the second connection regions 9b of the second layer of fabric 3 across the inflatable chamber 7, and vice-versa. The arrangement is such that the second connection regions 9b are each interposed between two adjacent first connection regions 9a, in the weft direction 11.

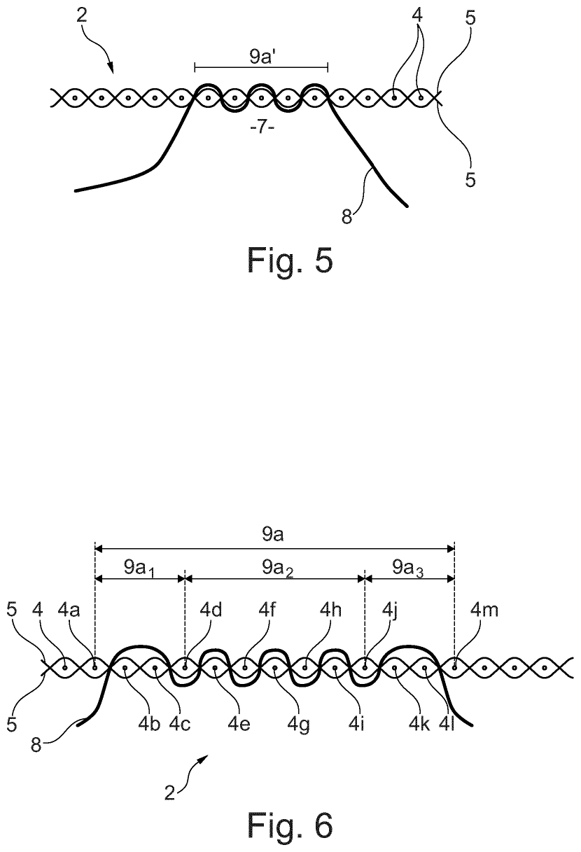

FIG. 5 illustrates one way in which the tether yarns 8 may each be implicated in the weave of either fabric layer 2, 3. For convenience, FIG. 5 illustrates a single tether yarn implicated 8 in the weave of the first fabric layer 2 within a sub-region 9a′ of a first connection region 9a, but it is to be appreciated that the tether yarn 8 may be implicated in the weave of the second fabric layer 3 within a second connection region 9b in substantially the same manner. As will be observed, the tether yarn 8 passes between two adjacent warp yarns 4 of the first fabric layer 2 from within the inflatable chamber 7 of the airbag, and is then interwoven between adjacent warp yarns 4 of the fabric layer 2 in a plain weave (i.e. passes over/under every other warp yarn 4) within the sub-region 9a′, before passing out of the fabric layer 2 on the side of the inflatable chamber 7 (and then extending towards a neighbouring sub-region 9a′, or towards the second fabric layer 3, which is not shown in FIG. 5). The sub-region 9a′ illustrated in FIG. 5 comprises a group of five adjacent warp yarns 4 with which the tether yarn 8 is interwoven. In other configurations, it is envisaged that the sub-regions 9a′, or the second connection regions 9b may comprise more or fewer warp yarns 4, for example three, seven, nine, eleven, thirteen, or indeed any convenient odd number, such that the tether yarn 8 will enter and exit the sub-region 9a′ or second connection region 9b from the side of the inflatable chamber 7. In arrangements in which the tether yarns 8 are interwoven with the yarns of the first layer of fabric 2 throughout the width (in the weft direction 11) of a first connection region 9a, it is proposed that the first connection region 9a may comprise more than five adjacent warp yarns 4, for example seven, nine, eleven, thirteen, or indeed any convenient odd number.

FIG. 6 illustrates another way in which the tether yarns 8 may each be implicated in the weave of either fabric layer 2, 3. For convenience, FIG. 6 illustrates a single tether yarn implicated 8 in the weave of the first fabric layer 2 within a first connection region 9a, but it is to be appreciated that the tether yarn 8 may be implicated in the weave of the second fabric layer 3 within a second connection region 9b in substantially the same manner. In this arrangement, the first connection region 9a comprises a first portion 9a₁, a second portion 9a₂ and a third portion 9a₃. Each portion 9a₁₋₃ of the connection region 9a comprises a respective number of warp yarns 4 of the fabric layer 2 and an arrangement in which the tether yarn 8 passes between or over the warp yarns 4.

In the first portion 9a₁ of the connection region 9a, the tether yarn 8 passes between two adjacent warp yarns 4a, 4b from the inwardly directed side of the fabric layer 2 defining the inflatable chamber 7 to the outer side of the fabric layer 2, and then partly around two adjacent warp yarns 4b, 4c. When the tether yarn 8 passes partly around two or more adjacent warp yarns in this manner, the tether is said to “float” over the adjacent warp yarns 6. In other configurations, the tether yarn 8 may float over more than two adjacent warp yarns 4 in the first portion 9a₁ of the connection region 9a. For example, the tether yarn 8 may float over three adjacent warp yarns 4 in the first portion 9a₁ of the connection region 9a. In the second portion 9a₂ of the connection region 9a, the tether yarn 8 passes between two warp yarns 4c, 4d from the outer side of the fabric layer 2 to the inwardly directed side, and the tether yarn 8 is interwoven with a predetermined number of single adjacent warp yarns 4d-4j in a plain weave. In the arrangement illustrated in FIG. 6, the tether yarn 8 is interwoven with seven adjacent single warp yarns 4d-4j within the second portion 9a₂ of the connection region 9a such that the tether yarn 8 passes at least partly around three warp yarns 4e, 4g and 4i on the outer side of the fabric layer 2. However, in other arrangements the tether yarn 8 may be interwoven with more than seven single adjacent warp yarns 4. For example, the tether yarn 8 may be interwoven with nine, or eleven, or thirteen single adjacent warp yarns 4 in the second portion 9a₂ of the connection region 9a.

In the third portion 9a₃ of the connection region 9a, the tether yarn 8 passes between two adjacent warp yarns 4j, 4k from the inwardly directed side of the fabric layer 2 to the outer side of the fabric layer 2, and then floats over two adjacent warp yarns 4k, 4l on the outer side of the fabric layer 2. The tether yarn 8 then passes between a further two adjacent warp yarns 4l, 4m, and back into the inflatable chamber 7 of the airbag 1. In other configurations, the tether yarn 8 may float over more than two adjacent warp yarns 4 in the third portion 9a₃ of the connection region 9a. For example, the tether yarn 8 may float over three adjacent warp yarns 4 in the third portion 9a₃ of the connection region 9a.

In the arrangements described above with reference to FIG. 6, the tether yarn 8 floats over at least two adjacent warp yarns 4 in the first and third portions 9a₁, 9a₃ of the connection region 9a, and is interwoven with single adjacent warp yarns 4d-4j in the second portion 9a₂ of the connection region 9a. Floating the tether yarn 8 over at least two adjacent warp yarns on one side of the fabric layer 2 in the first and third portions 9a₂, 9a₃ of the connection region 9a allows some movement between the tether yarn 8 and the inherent yarns 4, 5 of the fabric layer 2, which absorbs some of the shock load when the air-bag 1 is inflated. This can help to reduce the likelihood of the tether yarn 8 snapping as the airbag 1 is inflated.

In arrangements in which the tether yarns 8 are implicated in the weave of both fabric layers 2, 3 in the manner shown in FIG. 6, it is envisaged that the first connection regions 9a may be configured such that the tether yarn 8 is interwoven with a greater number adjacent warp yarns 4 within the second portion 9a₂ of each first connection region 9a than within the equivalent second portion of each second connection region 9b. In this way, the tether yarns 8 may be implicated in the weave of the first layer of fabric 2 throughout each first connection region 9a, such that the first connection regions 9a are wider in the weft direction 11 than the second connection regions 9b within which the tether yarns are implicated in the weave of the second layer 3. Alternatively, it is envisaged that each first connection region 9a may have the configuration shown in FIG. 6, whilst each second connection region 9b may have the (shorter) configuration shown in FIG. 5.

For the sake of convenience and clarity, FIG. 4 illustrates only two exemplary tether yarns 8, whilst FIGS. 5 and 6 each illustrate only single exemplary tether yarns 8. However, it is to be appreciated than in practical embodiments there may be significantly more tether yarns 8 arranged in a side-by-side relationship to one another, the tether yarns 8 being distributed amongst the weft yarns 5 of the two fabric layers 2, 3, so as to extend generally parallel to the weft yarns 5 and perpendicular to the warp yarns 4, and thereby collectively defining a tether having a width which extends some distance along the warp-direction of the fabric (i.e. into the page as FIGS. 4-6 are viewed). Indeed, in some embodiments it is proposed that the tether yarns may collectively define a tether having a width extending substantially entirely across the airbag, such that tether yarns are provided throughout the airbag. In other embodiments it is envisaged that the tether yarns 8 may be provided within a third layer of fabric woven from a third set of warp yarns and the tether yarns 8, wherein the tether yarns 8 define weft yarns of the third layer of fabric. Alternatively, the tether yarns 8 may be provided within a third layer of fabric woven in a manner such that the tether yarns 8 define warp yarns of the third layer.

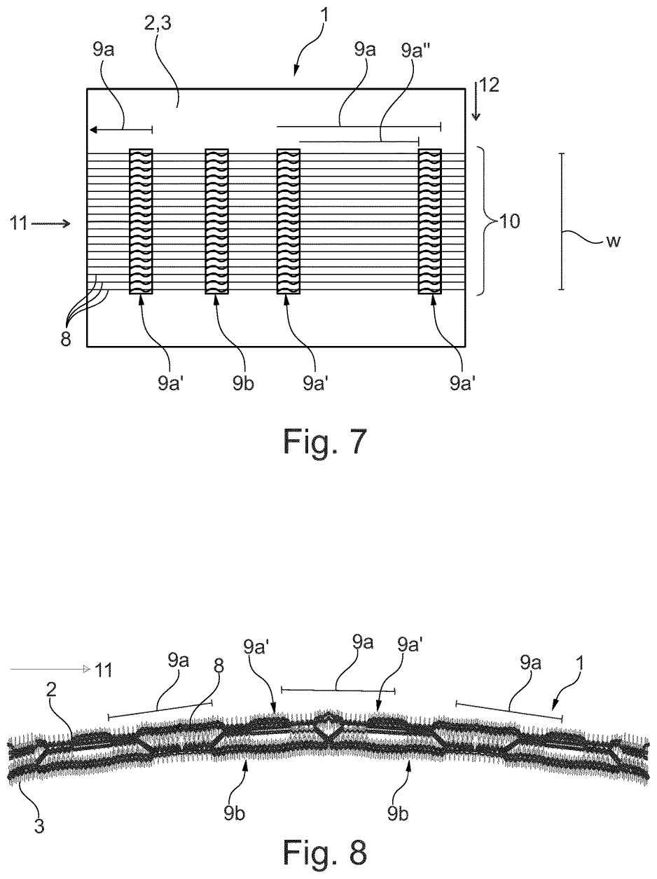

FIG. 7 schematically illustrates a region of the airbag 1 as viewed from above, with the first (upper) layer of fabric 2 superimposed on top of the second (lower) layer of fabric 3. The warp yarns 4 of the two layers 2, 3 are substantially aligned with the direction indicated by arrow 12, and the weft yarns 5 are substantially aligned with the direction indicated by arrow 11. A plurality of generally parallel tether yarns 8 are provided amongst the weft yarns 5. The tether yarns 8 are implicated in the weave of the upper layer 2 in a plurality of first connection regions 9a (only one complete first connection 9a being shown) which are spaced apart in the weft direction 11 of the fabric layers 2, 3, and each of which comprises a pair of connection sub-regions 9a′ and a central sub-region 9a″. The tether yarns 8 are also implicated in the weave of the lower layer 3 in a plurality of second connection regions 9b in the manner described above, although within the extent of the region of the airbag 1 illustrated in FIG. 7 only a single second connection 9b is shown. As will be observed, each connection sub-region 9a′ and each second connection region 9b is elongate so as to have a length in the warp direction 12. Each connection region 9a, 9b thus extends across a region of its respective layer of fabric 2, 3 so as to traverse a plurality of weft yarns. As will therefore be appreciated, the tether yarns 8 cooperate to define a tether 10 which has a width w in the warp direction 12 of the fabric layers 2, 3.

In the arrangement of FIG. 7, the tether yarns 8 are all interwoven with the same warp yarns 4 running through the two fabric layers 2, 3, such that the sub-regions 9a′ of the first connection regions 9a, and the second connection regions 9b are all parallel to one another and oriented such that their length direction is substantially parallel to the warp direction 12 and perpendicular to the weft direction 11. However, this is not essential, and indeed in some circumstances it can be beneficial to arrange the tether yarns 8 such that successive tether yarns 8 are implicated in the weave of the fabric layers 2, 3 by being interwoven with different groups of warp yarns 4 to one another. As will be appreciated by those of skill in the art, the effect of this can be to orientate the connection regions 9a, 9b so that their elongate extension traverses a plurality of weft yarns 5 at an oblique angle to the weft yarns, and also thus at an oblique angle to the warp yarns 4.

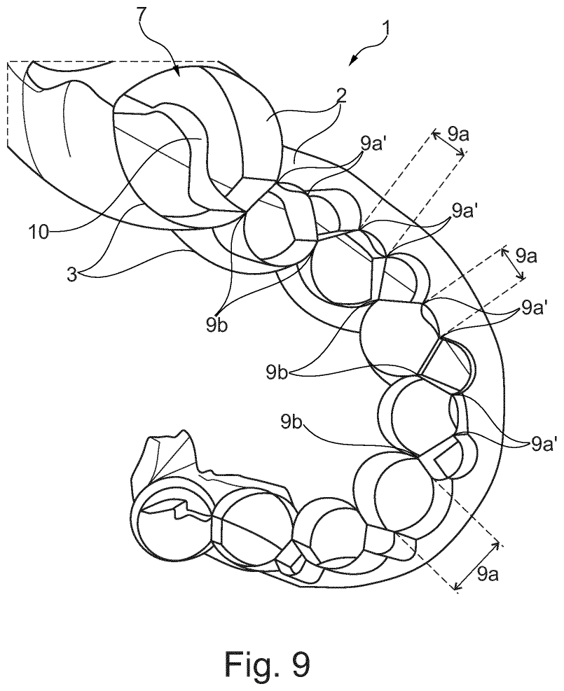

FIG. 8 is a view generally similar to that of FIG. 4, but which shows the airbag 1 in a partially inflated condition in which an initial volume of inflating gas has been directed into the inflatable chamber 7 of the airbag 1 so as to begin inducing curvature to the airbag. FIG. 9 is a perspective view showing a transverse cross section through an airbag 1 having a tether configuration of the type shown in FIGS. 4 and 8, but which shows the airbag 1 in a substantially fully inflated condition. FIG. 9 shows more clearly the width of the internal tether 10 which is defined by the tether yarns 8. As will be appreciated from both figures, the inflating gas urges the two fabric layers 2, 3 apart from one another, such that the airbag 1 achieves a degree of inflated depth across the inflatable chamber 7. Movement of the fabric layers 2, 3 apart from one another is restrained by the tether yarns 8 running through the airbag 1. As will be appreciated, the tether yarns 8 are placed under tension in this condition, and subjected to strain. Because of the above-described configuration of the first and second connection regions 9a, 9b where the tether yarns 8 are implicated in the weave of the first and second fabric layers 2, 3 respectively, with the first connection regions 9a in the first fabric layer 2 having a greater width in the length-direction of the tether yarns 8 than second connection regions 9b in the second fabric layer 3, the first and second connection regions 9a, 9b are subjected to different levels of strain to one another. It has been found that the effect of this is to induce curvature to the airbag 1 when it is inflated, as illustrated in FIG. 8 and particularly in FIG. 9. As will be observed, the above-described tether configuration is effective to induce curvature to the airbag 1, the curvature being convex on the side of the first fabric layer 2 (the layer with wider tether connection regions 9a), and concave on the side of the second fabric layer 3 (the layer with narrower tether connection regions 9b). The airbag 1 is thus configured to bend towards the second fabric layer 3 upon inflation. As will be appreciated, the airbag 1 bends about the longitudinal extension direction of the first and second connection regions 9a, 9b.

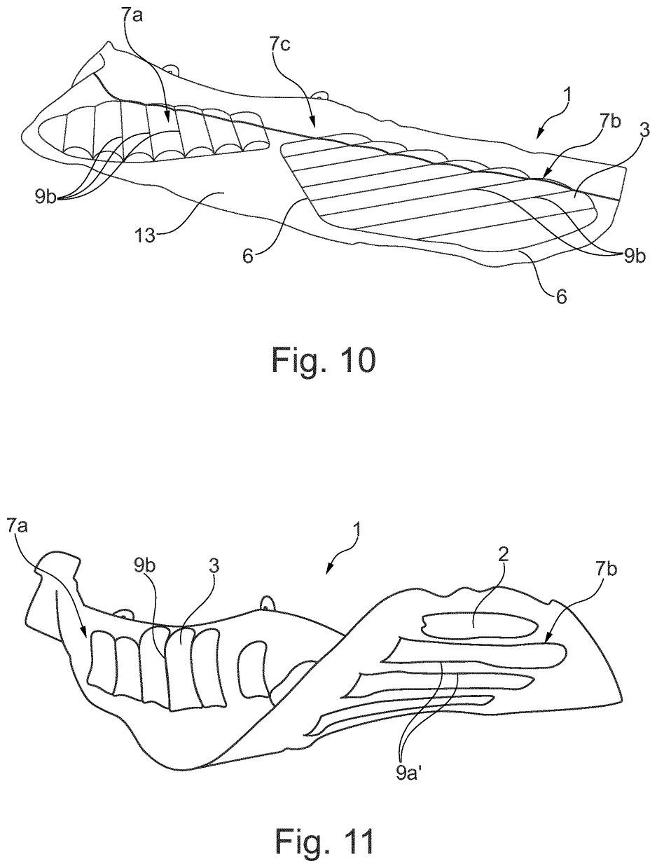

FIG. 10 illustrates a one-piece woven airbag 1 in accordance with the invention, in a pre-inflated configuration in which it is laid flat. The airbag 1 has a somewhat elongate configuration, and is shown with its second fabric layer 3 (the layer with the narrower second connection regions 9b) presented upwardly. The integral peripheral seam 6 of the illustrated airbag 1 follows a circuitous path having a re-entrant region such that the resulting inflatable chamber 7 of the airbag has a shape resembling a pair of spectacles, presenting two major chamber regions 7a, 7b which are fluidly interconnected by a narrower region 7c. Adjacent the re-entrant region of the peripheral seam 6, outside the inflatable chamber 7, the yarns of the two fabric layers 2, 3 are interwoven to define a non-inflatable region 13 of the airbag, in the manner of a thicker web of fabric.

The second connection regions 9b within which the tether yarns 8 are implicated in the weave of the second fabric layer 3 are also clearly visible in FIG. 10. As will be observed, a first group of the second connection regions 9b is provided in a region of the fabric layer 3 defining the first chamber region 7a, and a second group of the second connection regions 9b is provided in a region of the fabric layer 3 defining the second chamber region 7b. Although not visible in FIG. 10, first connection regions 9a within which the tether yarns 8 are implicated in the weave of the underlying first fabric layer 2 are also provided. Like the second connection regions 9b, the first connection regions 9a are similarly split into two groups—namely a first group provided in a region of the underlying first fabric layer 2 defining the first chamber region 7a, and a second group provided in a region of the underlying first fabric layer 2 defining the second chamber region 7b. The connection regions 9a, 9b in the first group (i.e. corresponding to the first chamber region 7a) are arranged to as to extend parallel to one another, whilst the connection regions 9a, 9b in the second group (i.e. corresponding to the second chamber region 7b) are also arranged to as to extend parallel to one another. However, it will be observed that the connection regions 9a, 9b of the first group are not parallel to the connection regions 9a, 9b of the second group.

Turning now to consider FIG. 11, the airbag 1 of FIG. 10 is illustrated in an inflated condition. As will be noted, the tether yarns 8 forming the first and second connection regions 9a, 9b of the first group (i.e. corresponding to the first chamber region 7a) serve to induce a first curvature to the first chamber region 7a of the airbag 1 such that it bends upwardly. Similarly, the tether yarns 8 forming the first and second connection regions 9a, 9b of the second group (i.e. corresponding to the second chamber region 7b) serve to induce a second curvature to the second chamber region 7b of the airbag 1 such that it also bends upwardly. As will be appreciated, the first chamber region 7a is thus caused to achieve an inflated shape in which it bends about the longitudinal extension direction of the first group of connection regions 9a, 9b, and the second chamber region 7a is thus caused to achieve an inflated shape in which it bends about the longitudinal extension direction of the second group of connection regions 9a, 9b. As will be noted, in this arrangement each chamber region 7a, 7b is thus configured to bend in a single direction, with the two directions being different to one another and defined by the direction of extension of the connection regions 9a, 9b across the local regions of the fabric layers 2, 3.

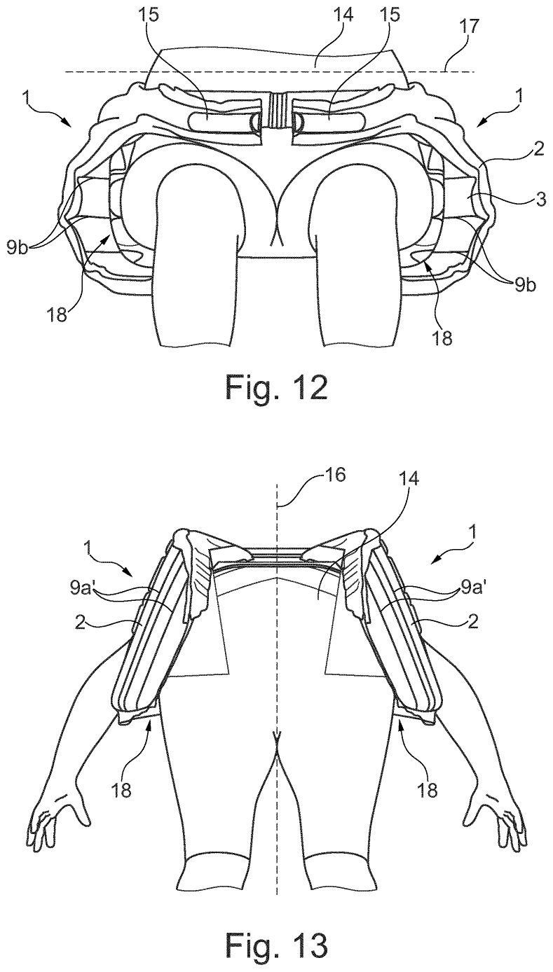

FIGS. 12 and 13 illustrate a practical embodiment of airbags 1 configured to bend in a single direction in the manner described above. The illustrated arrangement comprises a pair of hip-protection airbags 1 arranged and configured to provide hip protection to a person 14 in a sitting position. As shown in FIG. 12, each airbag 1 is provided with a respective inflator such as a gas generator 15 to direct a volume of inflating gas into the internal chamber 7 of the airbag 1. It is envisaged that the airbags 1 may be provided within a garment or the like which is configured to be worn by the person 14. The airbags 1 are arranged to inflate into respective deployed positions around a respective hip area of the person 14.

The airbags 1 of FIGS. 12 and 13 are configured so as to be optimised to provide good bending characteristics around the user's sagittal axis (indicated at 16 in FIG. 13) so that the airbags 1 each extend underneath the user's hips. This may be achieved by orientating the connection regions 9a, 9b (within which the tether yarns 8 are implicated in the constituent fabric layers 2, 3 of the airbags) so that they extend generally or approximately parallel to the user's transverse plane (indicated at 17 in FIG. 12). However, because the airbags 1 are configured to bend only around the user's sagittal axis 16, they are less well suited to bend around the sides of the user's hips, which results in the airbags 1 achieving respective inflated configurations in which they can flare outwardly from the user's rear hip area and away from the user's upper legs, leaving a gap 18 between the user's legs and each airbag 1, as illustrated in FIG. 2.

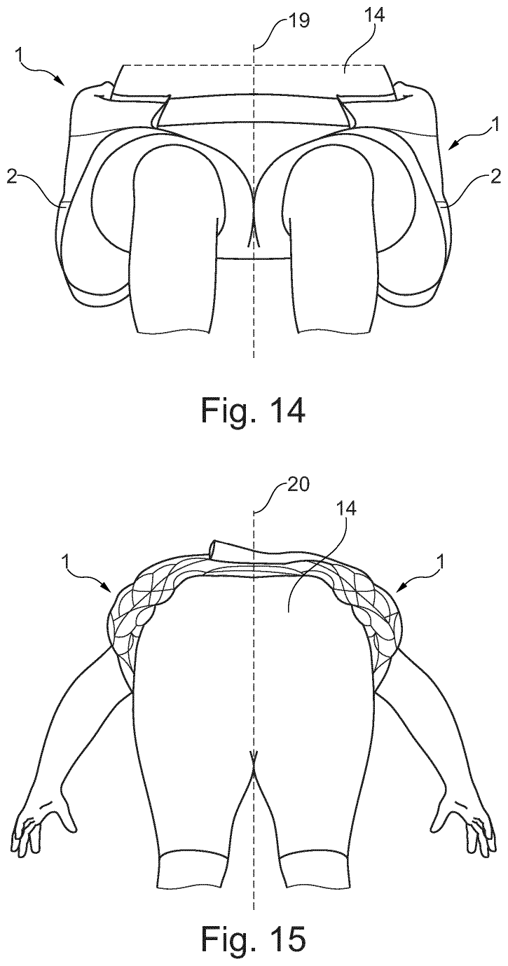

FIGS. 14 and 15 illustrate an alternative configuration of the hip protection airbags 1 shown in FIGS. 12 and 13, which are also configured to bend in a single direction in the manner described above. In this arrangement, however, the airbags 1 are configured so as to be optimised to provide good bending characteristics around the user's vertical axis (indicated at 19 in FIG. 14) so that the airbags better extend around the sides of the user's hips upon deployment, thereby addressing the potential shortcoming of the airbags 1 illustrated in FIGS. 12 and 13. This may be achieved by orientating the connection regions 9a, 9b (within which the tether yarns 8 are implicated in the constituent fabric layers 2, 3 of the airbags) so that they extend generally or approximately parallel to the user's sagittal plane (indicated at 20 in FIG. 12). However, because the airbags 1 are configured to bend only around the user's vertical axis 19, they are now less well suited to bend under the user's hips, which results in the airbags 1 achieving respective inflated configurations in which they provide less effective coverage underneath the user's hips than the airbags of FIGS. 12 and 13, as can be seen by comparing FIG. 15 with FIG. 13.

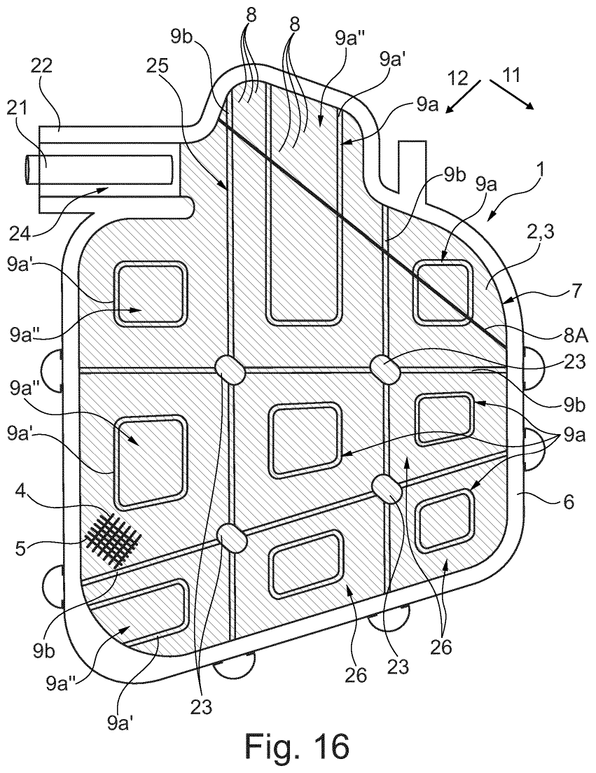

In some circumstances, it can therefore be desirable to provide an airbag which can be optimised to bend in two directions rather than merely one direction, and in particular which is configured to achieve double curvature upon inflation. With reference to FIGS. 16 to 22, there will now be described alternative airbags 1 in accordance with the present invention which have arrangements of tether yarns specifically configured to induce double curvature to the airbags upon inflation. The same reference numbers are used to denote identical features or features equivalent to those described above with reference to the embodiments of FIGS. 4 to 15.

The airbag 1 illustrated in FIG. 16 is shown in an uninflated configuration and takes the form of a hip-protection airbag of similar general concept to those illustrated in FIGS. 12 to 15 and which is thus configured to provide hip protection to a person. The airbag 1 may be incorporated into a protective garment which may be worn by the user. The airbag 1 is again formed from first and second layers of fabric 2, 3, each layer being woven from warp yarns 4 and weft yarns 5 (illustrated schematically in FIG. 16) and thus having a respective structure in the form of a weave. It is to be appreciated, however, that this embodiment of the invention may alternatively be applied to an airbag in which the layers of fabric are knitted layers, in which case the layers will each have a respective structure in the form of a knit comprising at least one yarn.

The two layers of fabric 2, 3 are arranged in superimposition, with the second layer 3 being arranged on top of the first layer 2 in the orientation illustrated from above in FIG. 16. The warp yarns 4 of the two layers 2, 3 are substantially aligned with the direction indicated by arrow 12, and the weft yarns 5 are substantially aligned with the direction indicated by arrow 11. The two layers 2, 3 are interconnected around their peripheral edges by a peripheral seam 6, thereby defining an inflatable chamber 7 between the layers 2, 3 for the receipt of inflating gas from an inflator such as a gas generator 21 which is received within an inlet neck 22 of the airbag defined by the peripheral seam 6 in a known manner. In the embodiment illustrated, the fabric layers 2, 3 are additionally directly interconnected at a plurality of nodes 23 located in a generally central region of the airbag 1. As will be appreciated by those of skill in the art of inflatable airbags, when the airbag 1 is inflated by the injection of inflating gas into the inflatable chamber 7 from the gas generator 21, the first layer 2 and the second layer 3 will be urged apart from one another within the region defined by the peripheral seam 6, except at the nodes 23 where the two layers 2, 3 are interconnected. The nodes 23 can thus be considered to define so-called ‘zero-depth’ features upon inflation of the airbag 1, because the inflatable chamber 7 will not achieve any inflated thickness at the positions of the nodes 23.

The airbag 1 may be woven via a so-called one-piece weaving technique, via which the two layers 2, 3 are woven simultaneously, with the yarns 4, 5 of the two layers 2, 3 being interwoven at predetermined regions to form the peripheral seam 6 and the nodes 23 as integral structural features of the airbag 1.

The airbag 1 further comprises a plurality of tether yarns 8 similar to those of the previously described arrangements, the tether yarns 8 being provided amongst the weft yarns 5. In the embodiment illustrated in FIG. 16, there are a large number of tether yarns 8 provided substantially throughout the inflatable chamber 7. The tether yarns 8 are arranged in a side-by-side relationship to extend generally parallel to the weft yarns 5 and perpendicular to the warp yarns 4 of the fabric layers 2,3. Each tether yarn 8 thus has a length-direction which is parallel to the length-direction 11 of the weft yarns 5 and which is perpendicular to the length-direction 12 of the warp yarns 4. As will therefore be appreciated, in the illustrated embodiment the tether yarns 8 collectively define a tether which extends substantially entirely across the airbag 1 (in the length-direction 12 of the weft yarns 4) such that tether yarns 8 are provided throughout the airbag 1. It is to be appreciated, however, that other embodiments are envisaged in which the tether yarns 8 may be provided only throughout a particular region of the airbag 1, with one or more other regions of the airbag 1 being substantially devoid of tether yarns 8.

Some of the tether yarns 8 are interwoven with warp yarns 4 of the first (lower) layer 2 in a plurality of first connection regions 9a which are spaced-apart from one another across the first (lower) layer 2. Such tether yarns 7 are thus implicated in the weave of the first (lower) layer 2 within said first connection regions 9a. And some of the tether yarns 8 are interwoven with warp yarns 4 of the second (upper) layer 3 in a plurality of second connection regions 9b so as to be implicated in the weave of the second (upper) layer 3 within the second connection regions 9b.

All but a few of the tether yarns 8 extend across the inflatable chamber 7 of the airbag from one point along the peripheral seam 6 to another point along the peripheral seam 6. In embodiments in which the airbag 1 is woven by the above-noted one-piece weaving technique, it is proposed that the end regions of each such tether yarn 8 may be interwoven with yarns of both fabric layers 2, 3 within the peripheral seam 6, thereby anchoring the ends of the tether yarn 8 to the peripheral seam 6. However, it will be noted that the embodiment illustrated in FIG. 16 has a small region 24 located within and adjacent the inlet neck 22 across which no tether yarns 8 extend. This is simply because the shape of the airbag around the inlet neck 22 does not allow tether yarns 8 to extend in the weft direction 12 across this region 24 so as to be anchored to a proximate part of the peripheral seam 6. Additionally, it may be desirable to leave the region 24 devoid of tether yarns 8 so that the gas generator 21 will not interfere with them. A small number of the tether yarns 8 are thus each anchored at one end to the nearest (in the weft direction 11) second connection region 9b, as indicated at 25 in FIG. 16 by being implicated in the weave of the first layer 2 in the manner described above.

As shown in FIG. 16, each of the second connection regions 9b, within which tether yarns 8 are implicated in the weave of the second (upper) layer 3, is configured so as to be generally elongate and to extend across the second (upper) layer 3 from one point along the peripheral seam 6 to another. It will also be noted that each of the second connection regions 9b traverses both the warp yarns 4 and the weft yarns 5 of the second (upper) layer 3 at an oblique angle. Furthermore, it will be noted that the second connection regions 9b are collectively arranged in a grid-like arrangement, with each second connection region 9b intersecting two others at respective nodes 23 at which the second (upper) layer 3 is directly connected to the first (lower) layer 2. As will be appreciated, and as shown in FIG. 16, the grid-like arrangement of the second connection regions 9b is effective to divide the second (upper) layer 3 into an array of sectors 26.

In the embodiment illustrated in FIG. 16, each of the first connection regions 9a, within which tether yarns 8 are implicated in the weave of the first (lower) layer 2, is configured to have a generally quadrilateral shape, albeit with slightly rounded corners. The plurality of first connection regions 9a may thus include generally square-shaped, generally rectangular-shaped, generally parallelogram-shaped, generally rhombus-shaped and/or generally trapezoid-shaped connection regions. It is to be noted that each first connection region 9a of the first layer 2 is offset relative to the second connection regions 9b of the second layer 3, so as to be located opposite a respective sector 26 of the second layer 3, and thus does not oppose any second connection region 9b across the inflatable chamber 7. Furthermore, it will also be noted that each of the first second connection regions 9a traverses both the warp yarns 4 and the weft yarns 5 of the first (lower) layer 2 at an oblique angle.

It is envisaged that each of the second connection regions 9b will be configured such that tether yarns 8 are implicated in the weave of the second layer 3 by being interwoven with warp yarns 4 of the second layer 3 substantially throughout the extent of the second connection regions 9b. In such an arrangement, tether yarns 8 defining each second connection region 9b will thus be interwoven with warp yarns 4 of the second layer 3 throughout the width of each second connection region 9b in the length-direction of the tether yarns 8 (i.e. generally parallel to the length-direction of the weft yarns 5). This may be achieved in the manner described previously with reference to FIG. 5, or in the manner described previously with reference to FIG. 6.

Similarly, in some embodiments it is envisaged that each (or at least one) of the first connection regions 9a may be configured such that tether yarns 8 are implicated in the weave of the first layer 2 by being interwoven with warp yarns 4 of the first layer 2 substantially throughout the extent of the or each first connection region 9a. In the case of such a first connection region 9a, tether yarns 8 defining the first connection region 9a may thus be interwoven with warp yarns 4 of the first layer 2 throughout the width of the first connection region 9a in the length-direction of the tether yarns 8. However, it is to be appreciated that this configuration of the first connection regions 9a is not considered essential, and indeed the particular embodiment illustrated in FIG. 16 does not have its first connection regions 9a configured in this way. Instead, the first connection regions 9a of the airbag 1 illustrated in FIG. 16 are each configured in a generally similar manner to the first connection regions of the previously described embodiment illustrated in FIG. 4, as will be described below in more detail.

The airbag 1 comprises several first connection regions 9a which are each spaced inwardly from the peripheral seam 6. Each of these first connection regions 9a comprises a central sub-region 9a″ within which no tether yarns 8 are implicated in the weave of the first layer 2. The central sub-region 9a″ is bordered by a border sub-region 9a′ throughout which tether yarns 8 are implicated in the weave of the first layer 2 (for example in the manner described above with reference to FIG. 4, or in the manner described above with reference to FIG. 5). Each of these first connection regions 9a is therefore configured such that at least some tether yarns 8 pass across the central sub-region 9a″ between parts of the border sub-region 9a′ which are spaced apart along the length-direction of the tether yarns 8 without being implicated in the weave of either the first layer 2 or the second layer 3—the tether yarns 8 thus passing across the first connection region 9a in the same manner as illustrated schematically in FIG. 4 and described previously. As will therefore be appreciated, within first connection regions 9a configured in this manner, tether yarns 8 are interwoven with warp yarns 4 of the first layer 2 only within the border sub-region 9a′.

The particular embodiment illustrated in FIG. 16 additionally comprises two first connection regions 9a which are provided adjacent the peripheral seam 6 so as to extend inwardly therefrom. These are located at the bottom left corner and at the top of the airbag 1, in the orientation illustrated in FIG. 16. Although somewhat similar to the other first connection regions 9a, each of these two particular first connection regions 9a is configured such that its central sub-region 9a″ (within which no tether yarns 8 are implicated in the weave of the first layer 2) is partially bordered by a similar border sub-region 9a′ (throughout which tether yarns 8 are implicated in weave of the first layer 2), but is also partially bordered by a length of the peripheral seam 6. As will therefore be appreciated, within first connection regions 9a configured in this manner, tether yarns 8 are interwoven with warp yarns 4 of the first layer 2 only within the border sub-region 9a′ or the peripheral seam 6.

In accordance with the previously described embodiments of FIGS. 4 to 15, it will be observed that the airbag 1 illustrated in FIG. 16 is configured such that its first connection regions 9a are each wider than the second connection regions 9b in the length direction 11 of the tether yarns 8.

As will also be observed, the plurality of tether yarns 8 provided throughout the airbag 1 include at least some which pass (in their length-direction 11) from one second connection region 9b, through a first connection region 9a, and then into another second connection region 9b. One such tether yarn is denoted at 8A in FIG. 16. Furthermore, at least some of the tether yarns 8 pass (in their length-direction 11) through a plurality of first connection regions 9a and through a plurality of second connection regions 9b, as also exemplified by the tether yarn denoted 8A in FIG. 16. In embodiments in which the first connection regions 9a include examples configured to comprise the above-noted arrangement of border sub-regions 9a′ at least partially bordering a central sub-region 9a″, at least some tether yarns 8 pass (in their length-direction) through a greater number of border sub-regions 9a′ (i.e where the tether yarns 8 are actually implicated in the weave of the first layer 2) than second connection regions 9b (i.e. where the tether yarns 8 are implicated in the weave of the second layer 3), as additionally exemplified by the particular tether yarn denoted 8A in FIG. 16 which passes through four border sub-regions 9a′ but only two second connection regions 9b in its length direction 11.

At least some of the tether yarns 8 pass from either a first connection region 9a or a second connection region 9b into the peripheral seam 6 of the airbag. The particular tether yarn denoted 8A in FIG. 16 also exemplifies this characteristic—its right-hand end passing from a first connection region 9a into the peripheral seam 6, and its left-hand end passing from a second connection region 9b into the peripheral seam 6.

As will also be appreciated, the airbag of FIG. 16 is configured such that, within its periphery defined by the peripheral seam 6, the tether yarns 8 are all interwoven with warp yarns 4 of its constituent fabric layers 2, 3 only within said connection regions 9a, 9b.

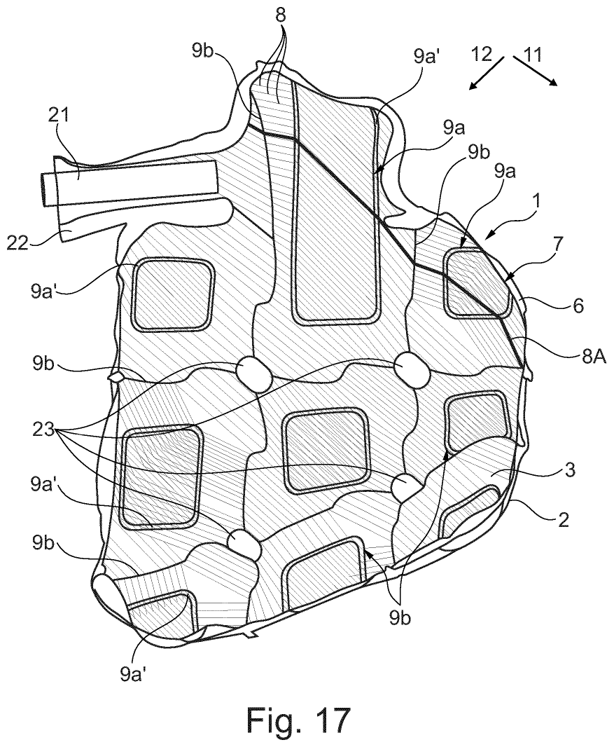

FIG. 17 illustrates the airbag of FIG. 16 in an inflated condition. Upon activation of the gas generator 21 in response to an actuation signal from an appropriate sensor (such as an impact or fall sensor, not shown), the gas generator 21 produces a large volume of inflating gas which is directed into the inflatable chamber 7 of the airbag 1. The inflating gas urges the two fabric layers 2, 3 apart from one another, such that the airbag 1 achieves a degree of inflated depth across the inflatable chamber 7, except at the locations of the ‘zero-depth’ nodes 23 where the two layers 2, 3 are interconnected. Movement of the fabric layers 2, 3 apart from one another is restrained by the tether yarns 8 running through the airbag 1. As will be appreciated, the tether yarns 8 are placed under tension in this condition and are subjected to strain. Because of the above-described configuration of the first and second connection regions 9a, 9b where the tether yarns 8 are implicated in the weave of the first and second fabric layers 2, 3 respectively, with the first connection regions 9a in the first fabric layer 2 having a greater width in the length-direction of the tether yarns 8 than second connection regions 9b in the second fabric layer 3, and the first connection regions 9a being located opposite respective sectors 26 defined by the second connection regions 9b so as not to oppose the second connection regions 9b across the inflatable chamber 7, the first and second connection regions 9a, 9b are subjected to different levels of strain to one another. It has been found that the effect of this is to induce double curvature to the airbag 1 when it is inflated.

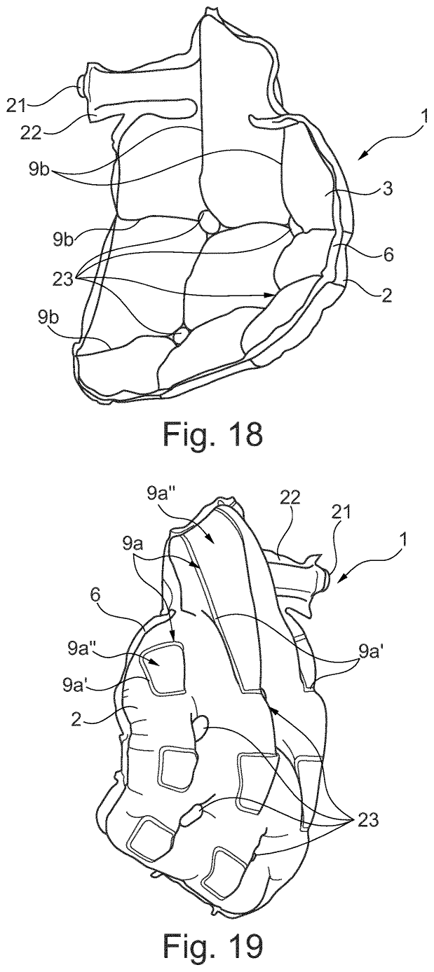

The double curvature achieved by the airbag 1 is shown most clearly in FIG. 18 (which shows the airbag in perspective view from the side of the second fabric layer 3) and FIG. 19 (which shows the airbag in perspective view from the side of the first fabric layer 2). As will be noted, the inflated airbag 1 is caused to adopt an inflated configuration in which it is generally convex towards the first layer 2 and generally concave towards the second layer 3. The double curvature is induced across the region of the airbag 1 which includes the grid-like arrangement of the second connection regions 9b in the second fabric layer 3, which in the case of the embodiment illustrated in FIG. 16 is substantially the entire airbag. As will be noted from FIG. 18 in particular, the curvature of the airbag 1 is induced about the elongate second connection regions 9b, which thus function as flexure lines. The double curvature arises at least in part because of the grid-like arrangement of the intersecting second connection regions 9b, and is further aided by the ‘zero-depth’ nodes 23.

Whereas the tether yarns 8 are all shown to lie parallel to one another and substantially in the plane of the page in the uninflated condition of the airbag 1 illustrated in FIG. 16, it will be appreciated from FIG. 17 that upon inflation of the airbag 1, the tether yarns are caused to adopt more of a three-dimensional path, the projection of which is rather more tortuous as viewed from above in FIG. 17. Also, the tension and strain applied to the tether yarns 8 causes them to move out of their initial regularly-arranged order as viewed from above in FIG. 16.

Considering the particular tether yarn 8A (which is the same yarn as denoted 8A in FIG. 16), it will be observed that when the airbag 1 is inflated, the tether yarn 8A extends (in its length direction from its left-hand end as illustrated in FIG. 1: from the peripheral seam 6—upwardly (i.e. out of the page as FIG. 17 is viewed) into a second connection region 9b at the second layer 3 (uppermost in FIG. 17)—a cross the second connection region 9b within the second fabric layer 3—downwardly (i.e. into the page as FIG. 17 is viewed) into a first part of the border sub-region 9a′ of the neighbouring first connection region 9a at the first layer 2 (lowermost in FIG. 17)—a cross the border sub-region 9a′ within the first layer 2 within the inflatable chamber 7 between the two layers 2, 3—into a second part of the border sub-region 9a′ of the same first connection region 9a within the first layer 2—across the border sub-region 9a′ within the first layer 2—upwardly into another second connection region 9b at the second layer 3—across the second connection region 9b within the second fabric layer 3—downwardly into a first part of the border sub-region 9a′ of another first connection 9a at the first layer 2—across the border sub-region 9a′ within the first layer 2 within the inflatable chamber 7 between the two layers 2, 3—into a second part of the border sub-region 9a′ of the same first connection region 9a within the first layer 2—across the border sub-region 9a′ within the first layer 2—and finally into the peripheral seam 6 at the right-hand end of the tether yarn 8A.

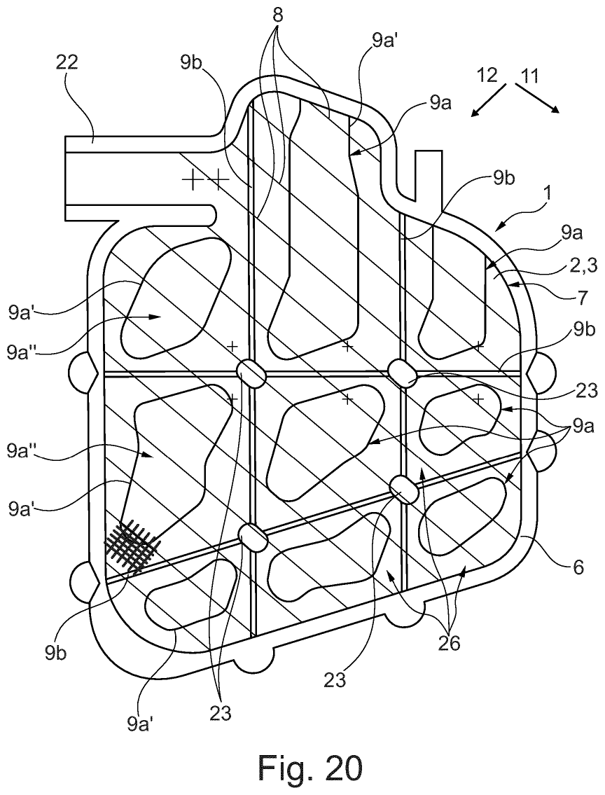

Turning now to consider FIGS. 20 to 22, another embodiment is proposed which is very similar in many respects to the embodiment described above with reference to FIGS. 16 to 19. The same reference numbers are therefore used to denote identical features or features equivalent to those described above with reference to the embodiment of FIGS. 16 to 19.

The airbag 1 illustrated in FIG. 16 is shown schematically in an uninflated configuration. The airbag comprises a plurality of tether yarns 8 in a substantially identical manner to the previously described embodiment shown in FIG. 16. The tether yarns 8 are thus again provided amongst the weft yarns 5 of the two fabric layers 2, 3. Although, for the sake of clarity, FIG. 20 illustrates only a relatively small number of tether yarns 8, it is to be understood that the airbag 1 of FIG. 20 is again provided with a large number of tether yarns 8 provided substantially throughout the inflatable chamber 7 in a similar manner to the embodiment of FIG. 16.

The airbag 1 of FIG. 20 is substantially identical to the airbag 1 of FIG. 16 in many respects which are not described again in detail. However, the airbag 1 of FIG. 20 differs from the airbag 1 of FIG. 16 in one respect—regarding the configuration of the first connection regions 9a within which tether yarns 8 are interwoven with warp yarns 4 of the first (lower) layer 2.

In the airbag 1 of FIG. 16, it was noted that each of the first connection regions 9a, within which the tether yarns 8 are implicated in the weave of the first (lower) layer 2, is configured to have a generally quadrilateral shape. The airbag 1 of FIG. 20 is different in this regard, because its first connection regions 9a are instead each configured to have a somewhat amorphous shape with a meandering periphery. Optionally, the shapes of the first connection regions 9a may also be different to one another.

In common with the embodiment of FIGS. 16 to 19, it is envisaged that each (or at least one) of the first connection regions 9a may be configured such that tether yarns 8 are implicated in the weave of the first layer 2 by being interwoven with warp yarns 4 of the first layer 2 substantially throughout the extent of the or each first connection region 9a. In the case of such a first connection region 9a, tether yarns 8 defining the first connection region 9a may thus be interwoven with warp yarns 4 of the first layer 2 throughout the width of the first connection region 9a in the length-direction of the tether yarns 8. However, it is to be appreciated that this configuration of the first connection regions 9a is not considered essential, and indeed the particular embodiment illustrated in FIG. 20 does not have its first connection regions 9a configured in this way. Instead, with the exception of their shape, the first connection regions 9a of the embodiment illustrated in FIG. 20 are configured in the same manner as those described above in relation to the embodiment of FIG. 16. It will therefore be appreciated that each first connection region 9a comprises a central sub-region 9a″ within which no tether yarns 8 are implicated in the weave of the first layer 2, with the central sub-region 9a″ being at least partially bordered by a border sub-region 9a′ throughout which tether yarns 8 are implicated in the weave of the first layer 2.

The shape of each individual first connection region 9a, and in particular its border sub-region 9a′, can be configured to optimise the local bending characteristic of the airbag 1, by adjusting and varying its spacing (in the length-direction 11 of the tether yarns 8) from the adjacent first connection region 9b, which thereby allows individual tether yarns 8 to extend different distances between the first connection region 9a and the adjacent first connection region 9b. As will be appreciated, this allows the bending characteristics of the airbag upon inflation to be fine-tuned.

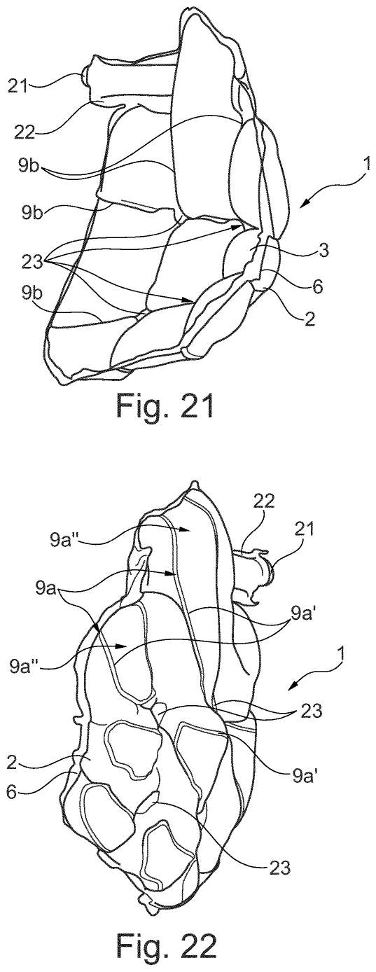

In all other respects, the configuration of the first and second connection regions 9a, 9b within which the tether yarns 8 are implicated in the weave of the first and second fabric layers 2, 3 respectively serves to induce double curvature to the airbag 1 in substantially the same manner as noted above in relation to the embodiment of FIGS. 16 to 19. The double curvature achieved by the airbag 1 is shown most clearly in FIG. 21 (which shows the airbag in perspective view from the side of the second fabric layer 3) and FIG. 22 (which shows the airbag in perspective view from the side of the first fabric layer 2). As will therefore be noted, the inflated airbag 1 is again caused to adopt an inflated configuration in which it is generally convex towards the first layer 2 and generally concave towards the second layer 3.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

Features of embodiments of the invention are set out in the following paragraphs:

Clause 1: An airbag (1) configured to be inflated by a source of gas, the airbag (1) being formed from first and second layers (2, 3) of fabric arranged in superimposition to define an inflatable chamber (7) between the layers (2, 3) for the receipt of inflating gas; each layer of fabric (2, 3) having a structure comprising at least one yarn (4,5), and the two layers (2, 3) being interconnected by at least one tether yarn (8) extending between the layers (2, 3) within the inflatable chamber (7), characterised in that: the or each tether yarn (8) is implicated in the structure of the first layer (2) within a plurality of first connection regions (9a), and is implicated in the structure of the second layer (3) within a plurality of second connection regions (9b); wherein each said first connection region (9a) is wider in a length-direction of the or each tether yarn (8) than each said second connection region (9b), and wherein said second connection regions (9b) are offset relative to said first connection regions (9a) such that said second connection regions (9b) do not oppose any said first connection regions (9a) across the inflatable chamber (7); the at least one tether yarn (8) thereby serving to induce curvature to the airbag (1) when its inflatable chamber (7) is inflated.

Clause 2: An airbag (1) according to clause 1, wherein said first connection regions (9a) are spaced apart from one another across at least a portion of said first layer (2), and said second connection regions (9b) are spaced apart from one another across at least an opposing portion of said second layer (3).

Clause 3: An airbag (1) according to clause 2, wherein the position on said second fabric layer (3) of at least one said second connection region (9b) is interposed between the positions on said first fabric layer (2) of two adjacent first connection regions (9a).

Clause 4: An airbag (1) according to clause 2 or clause 3, wherein no tether yarns (8) extend between any of said second connection regions (9b) without being implicated in the structure of the first layer (2) between said second connection regions (9b).

Clause 5: An airbag (1) according to any one of clauses 2 to 4, wherein at least one said first connection region (9a) comprises a plurality of spaced-apart connection sub-regions (9a′) within which the or each tether yarn (8) is implicated in the structure of said first layer (2), and wherein the or each tether yarn (8) extends between said connection sub-regions (9a′) of the or each first connection region (9a) without being implicated in the structure of either the first layer (2) or the second layer (3) between said connection sub-regions (9a′).

Clause 6: An airbag (1) according to any one of clauses 2 to 5, wherein each said layer (2, 3) of fabric is woven and has a weave comprising a plurality of generally parallel woven yarns (4)

Clause 7: An airbag (1) according to clause 6, wherein the or each tether yarn (8) is interwoven with yarns (4) of the first layer (2) within each said first connection region (9a), and is interwoven with yarns (4) of the second layer (3) within each said second connection region (9b).

Clause 8: An airbag (1) according to clause 7, wherein the or each tether yarn (8) is interwoven with yarns (4) of either said layer (2, 3) only within said connection regions (9a, 9b).

Clause 9: An airbag (1) according to clause 6 as dependent upon clause 5, wherein the or each tether yarn (8) is interwoven with yarns (4) of the first layer (2) only within said connection sub-regions (9a′) and is interwoven with yarns (4) of the second layer (3) only within said second connection regions (9b).

Clause 10: An airbag (1) according to any one of clauses 6 to 9, wherein said generally parallel woven yarns (4) of each layer of fabric (2, 3) are warp yarns (4), each layer of fabric (2, 3) further comprising a plurality of generally parallel weft yarns (5), and wherein the or each tether yarn (8) extends generally parallel to said weft yarns (5).

Clause 11: An airbag (1) according to any one of clauses 6 to 10, wherein said generally parallel woven yarns of each layer of fabric are warp yarns (4), each layer of fabric (2, 3) further comprising a plurality of generally parallel weft yarns (5), and wherein the inflatable airbag (1) comprises a plurality of said tether yarns (8), the tether yarns (8) extending generally parallel to said weft yarns (5) of the fabric layers (2, 3).

Clause 12: An airbag (1) according to clause 11, wherein each said connection region (9a, 9b) is generally elongate, said first and second connection regions (9a, 9b) extending generally parallel to one another and across respective fabric layers (2, 3) of the airbag (1) so as to traverse a plurality weft yarns (5) of the fabric layers (2, 3).

Clause 13: An airbag (1) according to clause 12, wherein said first and second connection regions (9a, 9b) traverse said plurality of weft yarns (5) at an oblique angle to said weft yarns (5), and traverse said plurality of warp yarns (4) at an oblique angle to said warp yarns (4).

Clause 14: An airbag (1) according to any one of clauses 6 to 13, wherein the airbag (1) is a one-piece woven airbag comprising at least one integrally woven seam (6) defined by a region in which yarns (4, 5) of the weave of one said layer (2, 3) are interwoven with yarns (4, 5) of the weave of the other said layer (3, 2).

Clause 15: An airbag (1) according to clause 14, wherein the or each tether yarn (8) is integrally woven into the weave of said layers (2, 3) within said connection regions (9a, 9b).

1-15. (canceled)

16. An airbag configured to be inflated by a source of gas, the airbag being formed from first and second layers of fabric arranged in superimposition to define an inflatable chamber between the layers for the receipt of inflating gas; each layer of fabric having a structure comprising at least one yarn, and the two layers being interconnected by a plurality of substantially parallel tether yarns extending in a length-direction across at least a region of the airbag and passing between the layers within the inflatable chamber, wherein:
said first layer comprising a plurality of spaced-apart first connection regions within which tether yarns selected from said plurality of tether yarns are implicated in the structure of said first layer; and said second layer comprising a grid-like arrangement of second connection regions within which tether yarns selected from said plurality of tether yarns are implicated in the structure of said second layer;
said grid-like arrangement of second connection regions dividing at least a region of said second layer into an array of sectors;
wherein said first connection regions are offset relative to said second connection regions such that each said first connection region of the first layer is located opposite a respective said sector of the second layer and does not oppose any said second connection region across the inflatable chamber; and
wherein said first connection regions are each wider than said second connection regions in the length-direction of said tether yarns, said tether yarns thereby serving to induce double curvature to the airbag when the inflatable chamber is inflated.

17. The airbag according to claim 16, wherein at least one said first connection region comprises a central sub-region within which no tether yarns are implicated in the structure of said first layer, said central sub-region being bordered by a border sub-region throughout which tether yarns are implicated in the structure of said first layer, such that at least some tether yarns pass across said central sub-region between parts of the border sub-region without being implicated in the structure of either the first layer or the second layer.

18. The airbag according to claim 16, wherein said airbag comprises a peripheral seam interconnecting said first and second layers to define said inflatable chamber, and wherein at least one said first connection region comprises a central sub-region within which no tether yarns are implicated in the structure of said first layer, said central sub-region being: (i) partially bordered by said peripheral seam so as to extend inwardly from said peripheral seam across said first layer; and (ii) partially bordered by a border sub-region throughout which tether yarns are implicated in the structure of said first layer, such that at least some tether yarns pass across said central sub-region between parts of the border sub-region without being implicated in the structure of either the first layer or the second layer.

19. The airbag according to claim 16, wherein at least one said first connection region is configured such that tether yarns are implicated in the structure of said first layer throughout the width of the first connection region in the length-direction of said tether yarns.

20. The airbag according to claim 16, wherein tether yarns are implicated in the structure of the second layer substantially throughout said second connection zones.

21. The airbag according to claim 16, wherein at least some of said tether yarns pass, in a length-direction of said tether yarns: from a said second connection region, through a said first connection region, and then into another said second connection region.

22. The airbag according to claim 16, said airbag comprising a peripheral seam interconnecting said first and second layers to define said inflatable chamber, and wherein at least some of said yarns pass, in a length-direction of said tether yarns, from either a said first connection region or a said second connection region into said peripheral seam.

23. The airbag according to claim 16, wherein at least some said tether yarns pass, in a length-direction of said tether yarns, through a plurality of said first connection regions and a plurality of said second connection regions.

24. The airbag according to claim 16, wherein said second connection regions intersect at nodes at which said first, and second layers are directly interconnected.

25. The airbag according to claim 16, wherein each said layer of fabric is woven and has a weave comprising a plurality of generally parallel woven yarns, said tether yarns being interwoven with said yarns of the first layer within each said first connection region, and being interwoven with said yarns of the second layer within each said second connection region.

26. The airbag according to claim 25, wherein said tether yarns are interwoven with yarns of said layers only within said connection regions.

27. The airbag according to claim 26, wherein at least one said first connection region comprises a central sub-region within which no tether yarns are implicated in the structure of said first layer, said central sub-region being bordered by a border sub-region throughout which tether yarns are implicated in the structure of said first layer, such that at least some tether yarns pass across said central sub-region between parts of the border sub-region without being implicated in the structure of either the first layer or the second layer; said at least one first connection region being configured such that said tether yarns are interwoven with yarns of the first layer only within the or each said border sub-region and are interwoven with yarns of the second layer only within said second connection regions.

28. The airbag according to claim 26, wherein said airbag comprises a peripheral seam interconnecting said first and second layers to define said inflatable chamber, and wherein at least one said first connection region comprises a central sub-region within which no tether yarns are implicated in the structure of said first layer, said central sub-region being: (i) partially bordered by said peripheral seam so as to extend inwardly from said peripheral seam across said first layer; and (ii) partially bordered by a border sub-region throughout which tether yarns are implicated in the structure of said first layer, such that at least some tether yarns pass across said central sub-region between parts of the border sub-region without being implicated in the structure of either the first layer or the second layer; said at least one first connection region being configured such that said tether yarns are interwoven with yarns of the first layer only within said peripheral seam or the or each said border sub-region and are interwoven with yarns of the second layer only within said second connection regions or said peripheral seam.

29. The airbag according to claim 25, wherein said generally parallel woven yarns of each layer of fabric are warp yarns, each layer of fabric further comprising a plurality of generally parallel weft yarns, and wherein said tether yarns extend generally parallel to said weft yarns of the fabric layers.

30. The airbag according to claim 29, wherein said first and second connection regions each traverse said weft yarns at an oblique angle to said weft yarns and traverse said warp yarns at an oblique angle to said warp yarns.
